(19) United States
(12) Patent Application Publication
(10) Pub. No.: US 2016/0110764 A1
(43) Pub. Date: Apr. 21, 2016

(54) PRESENTING CONTENT PACKAGES BASED ON AUDIENCE EXCLUSION

(71) Applicant: Apple Inc., Cupertino, CA (US)

(72) Inventors: Eswar Priyadarshan, West Roxbury, MA (US); Kenley Sun, Cambridge, MA (US); Dan Marius Grigorovici, Pleasanton, CA (US); Ravikiran Chittari, Acton, MA (US); Jayasurya Vadrevu, Lexington, MA (US); Prasad Rallabandi, Westford, MA (US)

(21) Appl. No.: 14/885,465

(22) Filed: Oct. 16, 2015

Related U.S. Application Data
(63) Continuation of application No. 12/790,106, filed on May 28, 2010, now abandoned.

(51) Int. Cl. G06Q 30/02; H04L 29/08

(52) U.S. Cl. CPC G06Q 30/0255; H04L 67/306; G06Q 30/0269

(57) ABSTRACT

The present technology maintains a profile for each user known to a content delivery system and selectively excludes delivery of certain content to some users based on past performance. The user profile includes a listing of all completed conversion actions associated with the invitational content presented to the user. When presented with a request for invitational content, the system identifies the set of all possible invitational content for the given context. Based on the user profile, the system removes from the set all invitational content for which the user has completed the associated conversion action to create a user-specific set of invitational content. The system selects an invitational content from the user-specific set of invitational content to include in the content package presented to the user.

### CROSS REFERENCE TO RELATED APPLICATIONS

This application is a continuation of, and claims the benefit of priority to, U.S. application Ser. No. 12/790,106, filed on May 28, 2010, which is expressly incorporated by reference herein in its entirety.

### BACKGROUND

1. Technical Field

The present disclosure relates to electronic content delivery and more specifically to intelligent targeting of invitational content to a user based on the user's previous activities.

2. Introduction

Targeted content delivery has long been an accepted means of conveying a desired message to an audience. Instead of creating a single message and delivering it to every member of the general public, content providers will attempt to identify the intended audience and shape the message so that it appeals to that audience. Once the content provider determines the intended audience they can target that audience by selecting the best content delivery channels. For example, if their intended audience is the residents of a particular city then delivering the message through the local newspaper or on a billboard in the city may be the appropriate channel. However, if their audience is a smaller subset of the population or is more geographically diverse such a delivery channel will be suboptimal. Content providers will also often target the content delivery by sculpting the content and appearance of the message for the intended audience. These techniques enable content providers to optimize their resources.

The development of digital content has enabled new techniques of targeting content to an audience. However, these techniques are often overly simplistic because targets are often selected based on a limited number of inputs. For example, if a user purchases a particular item on a website, additional related items can be suggested, or if a user visits a travel website, travel related content can be presented. Such methods are overly simplistic and fail to consider other important factors when targeting content to an audience.

The present disclosure recognizes that the use of personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The presently disclosed technology intelligently retargets invitational content to a user, and in some specific embodiments the user is a user of a device configured to communicate via a mobile network, i.e., a device that can be characterized in part by its use of a non-persistent connection, or multiple connections. It does so by first identifying a user on a network and analyzing usage data associated with that user. The usage data includes data describing contextual characteristics, which can be any data related to the user's network usage in one or more contexts such as usage data with respect to a presented item of invitational content, usage data with respect to conversions completed, and other data which is more fully described herein.

The collective data can be used to create one or more user profiles, which can be analyzed and used to allow a content delivery system to more intelligently select content for a user. In some embodiments, the more intelligently selected content avoids sending invitational content to a user that has already completed the invited conversion.

A system configured to practice the technology maintains a profile for each user known to the system. The user profile includes a listing of all completed conversion actions associated with the invitational content presented to the user. When presented with a request for invitational content, the system first identifies the set of all possible invitational content for the given context. Then, based on the user profile, the system removes from the set all invitational content for which the user has completed the associated conversion action. Finally, the system selects an invitational content from the subset of invitational content to include in the content package presented to the user.

In one example, the content delivery system can identify a user of a handheld communications device and maintain a pool of invitational content as candidates for distribution to the user. The content delivery system can further record completed conversion actions by the user and designate invitational content from the pool that is requesting the same completed conversion as exempt from distribution to the user.

In a more detailed example, the content delivery system can learn that an action constituting a conversion had already been completed before any invitational content was presented to the user. In such an instance, the invitational content can be removed from the pool of candidates or designated as exempt from distribution even though it was not presented to the user.

In another example, a conversion action can take place on the handheld communication device, which can report the conversion action to the content delivery system. Invitational content requesting a conversion that was already completed on the device will no longer be a candidate for presentation to the user. However, if the conversion is un-done, e.g. the conversion requires a program download, but the program is later deleted, the device can also report the un-done conversion and the invitational content's exempt status can be removed.

In another example, a user may have two or more devices. In such instances, an item of invitational content might be designated as exempt from presentation to the user on one device, but not another. Such a situation could arise if the conversion action required download of additional content and the additional content is downloaded to only one device. The user could then still receive ads on the device that has not yet downloaded the additional content.

The examples provided above are merely illustrative of some of the ways which exempting invitational content from presentation to a user can be beneficially employed. Additional examples can be found herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary method embodiment;

FIG. 3 illustrates an exemplary method embodiment;

FIG. 4 illustrates an exemplary configuration of devices and a network associated with an audience exclusion scenario; and

FIG. 5 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The present disclosure addresses the need in the art for improved methods of selecting invitational content presented to a user based on the user's interactions with previously presented invitational content.

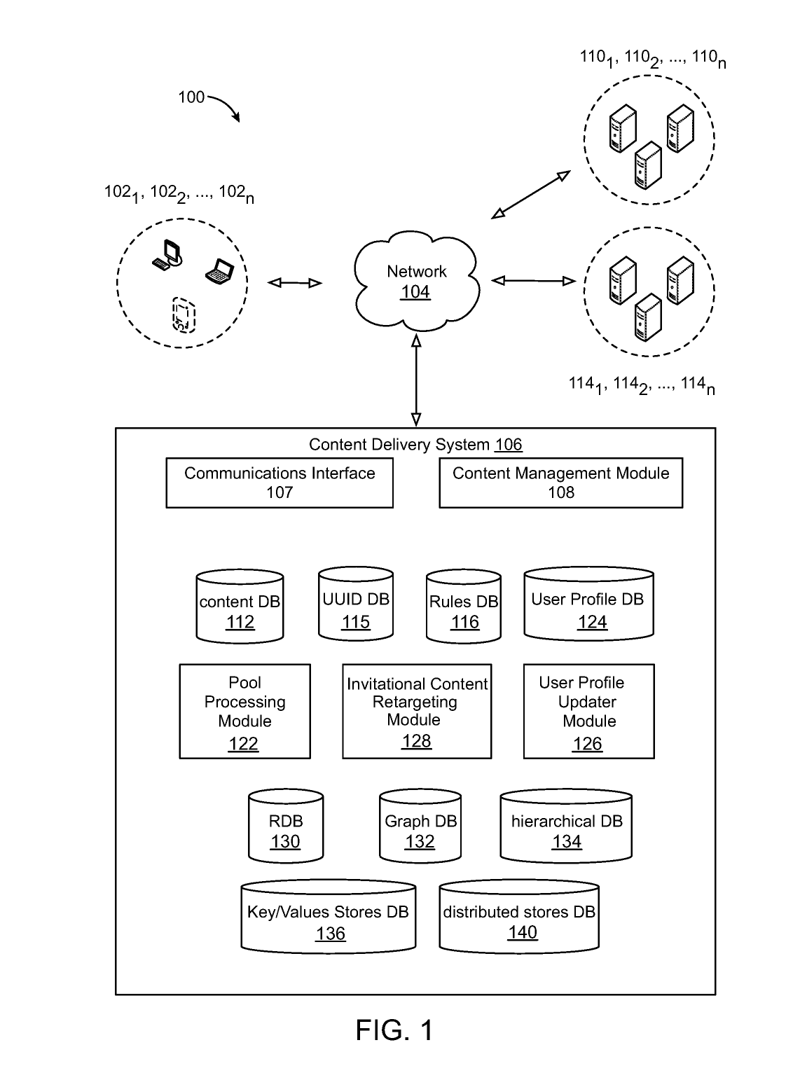

The presently disclosed system and method is particularly useful for assembling and delivering targeted content to a user. An exemplary system configuration 100 is illustrated in FIG. 1 wherein electronic devices communicate via a network for purposes of exchanging content and other data. The system can be configured for use on a local area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a content package is delivered to user terminals 102₁ . . . 102ₙ (collectively “102”) connected to a network 104 by direct and/or indirect communications with a content delivery system 106. In particular, the content delivery system 106 receives a request for an electronic content, such as a web page, an application, or media, etc., from one of user terminals 102. Thereafter, the content delivery system 106 assembles a content package in response to the request and transmits the assembled content package to the requesting one of user terminals 102. In some embodiments, the server has preassembled the content package before the request is received. The content in the assembled content package can include text, graphics, audio, video, executable code or any combination thereof. Further, the assembled content packages can include invitational content designed to inform or elicit a pre-defined response from the user and that can vary over time. The content delivery system can include a communications interface 107 to facilitate communications with the user terminals 102 and any other components familiar to those of ordinary skill in the art.

The content delivery system 106 includes a content management module 108 that facilitates generation of the assembled content package that includes invitational content. Specifically, the content management module can combine content from one or more primary content providers 110₁ . . . 110ₙ (collectively “110”) and content from one or more secondary content providers 114₁ . . . 114ₙ (collectively “114”) to generate the assembled content package for the user terminals 102. In some embodiments, the content management module can create a package from only secondary content, or only secondary content. The package need not contain both primary and secondary content.

Although, primary and secondary providers 110, 114 are presented herein as discrete, separate entities, this is for illustrative purposes only. In some cases, the primary and secondary providers 110, 114 can be the same entity. Thus, a single entity may define and provide both primary and secondary content. Although, both the primary and secondary content can comprise invitational content, in most instances, the secondary content will comprise the invitational content portion.

For example, in the case of a web page delivered to a requesting one of user terminals 102, the content management module 108 can assemble a content package by requesting the data for the web page from one of the primary content providers 110 maintaining the web page. Then the time-varying invitational content on the web page, which is provided by the secondary content providers 114, is obtained according to the arrangement between the primary and secondary content providers 110 and 114. For example, the invitational content from the secondary providers 114 can be selected based on a guaranteed number of impressions. Alternatively, the invitational content from the secondary providers 114 can be selected based on the context of the web page. In another example arrangement, the primary content can be sent separately, from a source other than the content delivery system disclosed here, or the primary content can have been previously downloaded and cached on the user terminal 102 requesting the content. In such instances, the content delivery system can send a content package containing time-varying invitational content for use, or display with, or related to, the primary content. However, any other arrangements and configuration for selecting invitational content from the secondary providers 110 can also be used.

Although the content management module 108 can be configured to request that data be sent directly from content providers 110 and 114, a cached arrangement can also be used to improve performance of the content delivery system 106 and improve overall user experience. That is, the content delivery system 106 can include a content database 112 for locally storing/caching content maintained by content providers 110 and 114. The data in the content database 112 can be refreshed or updated on a regular basis to ensure that the content in the database 112 is up to date at the time of a request from a user terminal. However, in some cases, the content management module 108 can be configured to retrieve data directly from content providers 110 and 114 if the metadata associated with the data in content database 112 appears to be outdated or corrupted.

In the various embodiments, the content delivery system 106 can also include a unique user identifier (UUID) database 115 that can be used for managing sessions with the various user terminal devices 102. The UUID database 115 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 115. Such an assignment can be provided by analyzing requesting device attributes in order to determine whether such requests can be attributed to the same device. Such attributes can include device or group-specific attributes.

As described above, content maintained by the content providers 110 and 114 can be combined and/or presented according a predefined arrangement between the two content providers, which can be embodied as a set of rules. In an arrangement where the content delivery system assembles the content package from multiple content providers, these rules can be stored in a rules database 116 in content delivery system 106 and content management module 108 can be configured to assemble the content package for user terminals 102 based on these rules. The rules can specify how to select content from secondary content providers 114 and the primary content providers 110 in response to a request from one of user terminals 102. For example, in the case of a web page maintained by one of primary providers 110 and including variable advertisement portions, the rules database 116 can specify rules for selecting one of the secondary providers 114. The rules can also specify how to select specific content from the selected one of secondary providers 114 to be combined with the content provided by one of primary providers 110. Once assembled, the assembled content package can be sent to a requesting one of user terminals. However, the content package is not limited to the content from content providers 110 and 114. Rather, the content package can include other data generated at the content delivery system 106.

As described above, arrangements between the content providers 110 and 114 can result in content from one of primary content providers 110 being combined with invitational content from multiple ones of secondary content providers 114, based on the rules database 116. Although the rules database 116 can be accessed each time a request is received from one of user terminals 102, such a configuration can limit performance. Therefore, in many cases, the rules in rules database 116 are used to define at least one pool of invitational content from the secondary providers 114. Thus, when the content management module 108 assembles a content package, the content management module 108 first constructs and/or retrieves the pool. Thereafter, the content management module 108 can select an invitational content from one of the secondary content providers from the pool and form the assembled content package.

As used herein, the term “contextual characteristics” refers to the characteristics of a particular content package as related to a particular audience in the network 104 associated with one or more of user terminals 102. Contextual characteristics can include channel characteristics, demographic characteristics, behavioral characteristics, and spatial-temporal characteristics. Channel characteristics can define the specific delivery channel being used to deliver a content package. For example, channel characteristics can include a type of electronic content, a type of device or user terminal, a carrier or network provider, or any other characteristic that defines a specific delivery channel for the content package. Spatial-temporal characteristics can define a location, a date, a time, or any other characteristic that defines a geographic location and/or a time for delivery of the content package. Demographic characteristics can define personal and/or socio-economic characteristics of the user requesting the content package. Behavioral characteristics can define user behaviors for one or more different types of content, separately or in combination with any other contextual characteristics. That is, different behavioral characteristics may be associated with different channel, demographic, or spatial temporal characteristics. For example, users may be associated with higher conversion or response rates for some types of delivery channels.

One concern with the arrangements typically entered into by secondary content providers 114 is that they can result in invitational content of little or no interest being presented to users many times. As a result, even though a desired number of impressions can be achieved, the rate of response to such invitational content may be low and/or the resulting targeted audience may be incorrect or suboptimal. As a result, content providers 110 and 114 can be negatively impacted. For example, if the primary content providers 110 receive compensation based on the number or rate of conversions of invitational content provided by secondary content providers 114, the resulting low conversion rate will result in lower revenues for the primary content providers 110. At the same time, the lower number or rate of conversions of invitational content can result in lower exposure or sales for the secondary content provider 114. In the case of an arrangement based on the number of impressions, the primary content provider 110 would be compensated, but the lower number or rate of conversions of invitational content can result in lower exposure or sales for the secondary content provider 114. As a result, such secondary content providers 114 may opt to pursue relationships with other primary content providers 110, resulting in potential loss of revenues for some primary content providers 110.

The various embodiments therefore provide systems and methods for improving audience targeting by managing the presentation of invitational content from such secondary content providers 114. In particular, systems and methods are provided for adjusting invitational content within content delivery system 106 in order to provide invitational content at a user terminal that is of greater interest to an associated user. As a result, improved targeting of users is provided, which generally correlates to an increase in desired responses or conversions. In the various embodiments, the invitational content is adjusted based on the user's interactions with previously presented invitational content. As a result, the invitational content is presented in a manner and/or at a time that will likely elicit greater response from the requesting user.

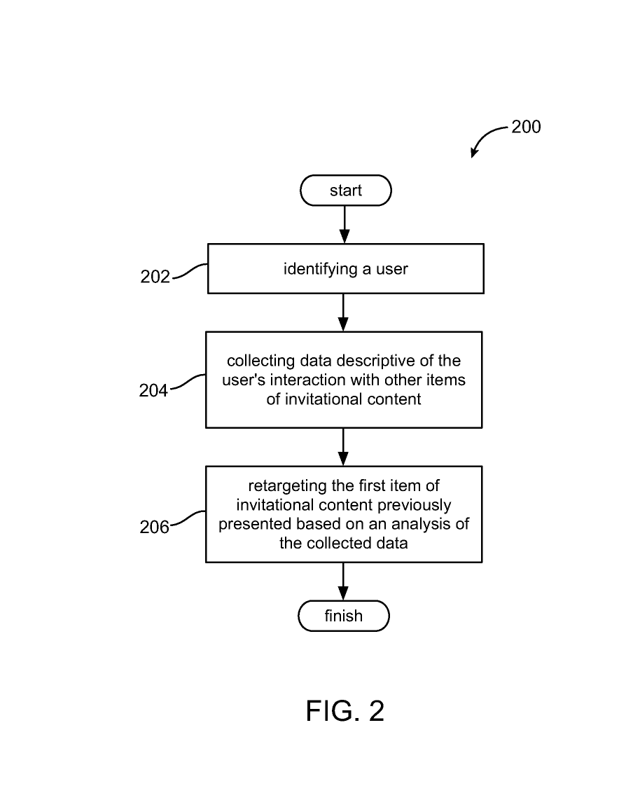

In some embodiments, delivery system 106 can provide an invitational content retargeting module 128 for retargeting invitational content previously presented. The invitational content retargeting module 128 receives the invitational content, a context associated with a request, and identifying information for the user associated with the request. For example, such information can be received from the content management module 108 or other components in system 100. Thereafter, the invitational content retargeting module 128 can access a user profile database 124 to retrieve a user profile of previously presented invitational content and adjust the invitational content accordingly. The retargeted invitational content can then be provided, for example, to the content management module 108, which can thereafter assemble and deliver a content package to the requesting user terminal. Such a method is described in greater detail below with respect to FIG. 2.

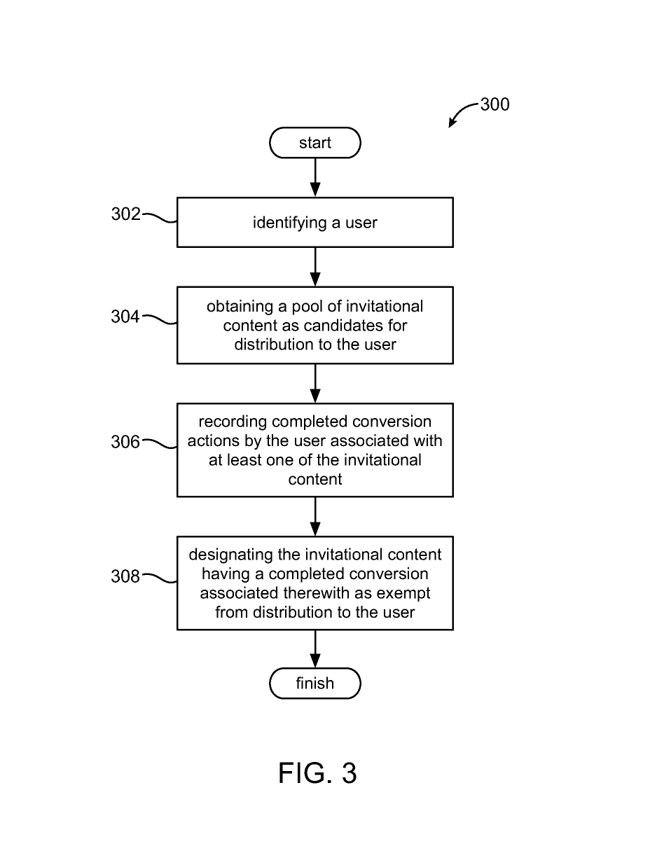

In operation, delivery system 106 can provide a pool processing module 122 for creating a user-specific pool of invitational content. A pool-processing module 122 receives contextual characteristics and identifying information for the user associated with the request. Such information can be received from the content management module 108 or other components in system 100. The pool-processing module 122 operates on a pool of invitational content. The pool-processing module 122 can receive the pool along with the content and user identification or, alternatively, it can construct the pool. The pool processing module 122 can construct the pool by retrieving invitational content from the content database 112, the content management module 108, or directly from content providers 110 and 114. If the pool of invitational content has not already been adjusted to eliminate content not applicable to the contextual characteristics, the pool-processing module 122 can make this adjustment. Thereafter, the pool-processing module 122 can access a user-profile database 124, which can be constructed based at least in part on recorded contextual characteristics related to the user, to retrieve a user profile of previously presented invitational content to create the user-specific pool. The user-specific pool can then be provided, for example, to the content management module 108, which can thereafter assemble and deliver a content package to the requesting user terminal. Such a method is described in greater detail below with respect to FIG. 3.

In the various embodiments, the user-profile database 124 can be updated using a user-profile-update module 126. In some cases, the user-profile-update-module 126 can be configured to add additional profile data to the profile database 124. However, in other cases, an extended profile of user interactions with invitational content may not accurately reflect a current interest of users. Accordingly, update module 126 can also be configured to maintain the profile database 124 to include only more recently acquired data. For example, the update module 126 can be configured to maintain the profile database 124 to include only data from the last two to three months. However, the update module 126 can be configured to adjust the data in profile database 124 to cover any span of time. In some instances the update module 126 can update the profile database 124 in real-time. In some instances, the update module 126 can update the profile database 124 at least every week, or every day.

In the various embodiments, the system can include one or more additional databases implemented using various data structures such as, but not limited to, a relational database (RDB) 130, a graph database 132, a hierarchical database 134, a key/values stores database 136, and a distributed stores database 140.

FIG. 2 is a flowchart illustrating steps in an exemplary method 200 for retargeting invitational content based on a user's past interactions with invitational content. For the sake of clarity, this method is discussed in terms of an exemplary system such as is shown in FIG. 1. Although specific steps are shown in FIG. 2, in other embodiments a method can have more or less steps than shown. First, the content delivery system 106 identifies the user associated with the user terminal (202). This identification can be performed in a variety of ways. For example, as described above, when the delivery system 106 receives a request for a content package, the request can include some identifying information, associated with the requesting user terminal or the associated user. This information can then be correlated to an entry in the UUID database 115 to retrieve an identity of the user. In other configurations, the user can be identified by analyzing the requesting device's attributes in order to determine whether such requests can be attributed to a same device, also as described above. Other methods can also be used.

Meanwhile, the content delivery system 106 collects data descriptive of the user's interaction with one or more other items of invitational content within the network (204). The collected data can include any number of characteristics associated with a user's interaction with invitational content or any contextual characteristics such as channel, demographic, behavioral, and/or special-temporal characteristics. For example, the information can include where on the conversion continuum the user abandoned the process: did the user take the first step of maybe clicking on a supplied link or did the user make it all the way to placing an item in their electronic shopping cart. Additionally, information can be collected about the invitational content itself, e.g. colors, size, font, or what was actually offered. Alternatively, the system can make use of the relationship between the primary and secondary content, e.g. were the two tightly related or completed unrelated. The information can further include the channel, the device the user was using, the time of day, and/or day of week. A more extensive data set, both in terms of what is collected and for how many items of invitational content, can lead to more effective retargeting.

As discussed above, the delivery system 106 includes a user profile database 124. In some embodiments, the collected data can be stored in the user profile database 124. The delivery system 106 can receive a direct request to update one or more user profiles. The update request can come directly from the user or any other device capable of communicating with the delivery system 106, such as other content delivery networks or websites. The update request can occur at any time. The update request can include any of the collected data described above such as characteristics of one or more user's interaction with invitational content and/or contextual characteristics. Alternatively, the request for a content package can include the collected data. Once received, the collected data can be supplied to the user-profile-update module 126, which will update the user profiles for the users identified in the request.

The content delivery system 106 retargets the first item of invitational content previously presented based on an analysis of the collected data (206). In some embodiments, the collected data along with either the invitational content or a description of the invitational content is supplied to the invitational content retargeting module 128. The retargeting module 128 analyzes the data and reformulates the invitational content such that when presented to the user, the user is more likely to complete the associated conversion action. The reformulation can include such actions as altering the presentation of the content, e.g. changing the colors, fonts, etc.; adding to the invitational content; switching the invitational content for one that is similar; or switching the invitational content for one that is entirely different. Once retargeted, the invitational content can be used in the content package presented to the user.

In some embodiments, the content delivery system 106 retargets invitational content by re-presenting the first item of invitational content on a channel that that the user is known to have previously converted other items of invitational content. Often users are more likely to complete a conversion on invitational content presented through one channel rather than another. For example, a user may be more likely to purchase an advertised item when it is presented to them on a social networking site, but will not click the link for the item when it is presented to them on a news site. However, that same user may be willing to fill out an informational survey on the news site, but not the social networking site. An analysis of the collected data could reveal this propensity, thus, the user can be retargeted in a channel where the user is more likely to complete a conversion for the type of invitational content being offered.

In some embodiments, the content delivery system 106 retargets invitational content by re-presenting the first item of invitational content with an added incentive to complete the associated conversion action. For example, in many cases users will be presented with an advertisement to purchase a particular item only to abandon the purchase just prior to completing the transaction. In some cases this may occur because the user decided to comparison shop. An analysis of the collected data could reveal that the failed conversion resulted from comparison shopping. Based on this information the secondary content provider can retarget the user with an advertisement for the same item, but now the advertisement could include a discount or a bonus item.

In some embodiments, the content delivery system 106 retargets invitational content by re-presenting the first item of invitational content at a time when the user is more likely to complete the associated conversion action. Some items of invitational content can be timing sensitive. That is, content which when presented during a specific time of day or on a specific day of the week is more likely to fail to result in a conversion. However, if the very same item of invitational content is presented at a different time or on a different day, the rate of conversion is significantly higher. For example, if the user is presented with an invitation to watch a sporting event during their workday, they are unlikely to complete the conversion. However, if the user was presented with the same invitational content outside of their workday, e.g. in the evening, their rate of conversion increases. Furthermore, their rate of conversion may still further increase if the same invitational content is presented on their weekend. This limitation of presenting invitational content could be addressed by assuming a conventional workweek. However, more accurate retargeting can be achieved through the presently disclosed method by analyzing the collected data.

In some embodiments, the content delivery system 106 retargets invitational content by presenting a similar item of invitational content that has a lower conversion value than the first item of invitational content. For example, initially the user was presented with an offer to purchase the full version of a mobile phone application. At the time of the initial offer, the user may not have been convinced that the application would be worth the cost. In this situation, the content delivery system 106 can retarget the user by presenting a lite version of the application at either a reduced cost or for free. Additionally, whether the lite version is offered at a reduced cost or for free could be based on an analysis of the collected data.

Retargeting at a lower conversion value can also take the form of a conversion that requires less user action. For example, a possible conversion action could be getting a user to complete a form that requests a variety of contact information such as name, address, phone number, email address, etc. The user may be unwilling to complete such an extensive form either because of the amount of time required to complete the form or because they do not want to provide that much personal information. Analysis of the collected data could indicate that the user would likely complete the conversion if only required to supply a name and email address. This can have a lower conversion value for the secondary content provider, but a greater value than a completely failed conversion.

In some embodiments, the content delivery system 106 retargets invitational content by presenting a similar item of invitational content that has a higher conversion value than the first item of invitational content. For example, initially the user was presented with an offer for a lite version of a mobile phone application either for free or for a reduced price in comparison with the full version of the application. At the time of the initial offer, the user installed the lite version of the application. Analysis of the collected data could indicate first that the user downloaded and installed the lite version and second whether the user has used the lite version of the application. If so, the content delivery system 106 can retarget the user by presenting a full version of the application.

FIG. 3 is a flowchart illustrating steps in an exemplary method 300 for creating the user-specific pool of possible invitational content that can be used in a content package presented to the user. For the sake of clarity, this method is discussed in terms of an exemplary system such as is shown in FIG. 1. Although specific steps are shown in FIG. 3, in other embodiments a method can have more or less steps than shown. To create a user-specific pool, the content delivery system 106 identifies the user associated with the user terminal (302). This identification can be performed in a variety of ways. For example, as described above, when the delivery system 106 receives a request for a content package, the request can include some identifying information, associated with the requesting user terminal or the associated user. This information can then be correlated to an entry in the UUID database 115 to retrieve an identity of the user. In other configurations, the user can be identified by analyzing the requesting device's attributes in order to determine whether such requests can be attributed to a same device, also as described above. Other methods can also be used.

The content delivery system 106 obtains a pool of invitational content as candidates for distribution to the user (304). The pool can consist of the actual invitational content and/or references to invitational content. This pool of content can be obtained in a number of ways. For example, as described above, the delivery system 106 can include a content database 112 where content is locally stored/cached. Alternatively, the content management module 108 can be configured to retrieve data directly from content providers 110 and 114.

In one embodiment, the obtained pool could contain all invitational content known by the delivery system 106. Alternatively, the obtained pool could be a subset of all invitational content based on contextual characteristics such as channel, demographic, behavioral, and/or spatial-temporal characteristics. As described above, when the delivery system 106 receives a request for a content package the request can include contextual characteristics. Then these characteristics can be used by the content management module to select only content applicable to the contextual characteristics from the content database 112 or to only retrieve data from one or more of content providers 110 and 114 that are associated with the contextual characteristics. For example, if the primary content can only be packaged with invitational content from a single secondary content provider, then the initial pool would only include invitational content supplied by that secondary content provider. Alternatively, if invitational content is designed to target particular demographics of users then only content matching the demographic of the user would be included.

Meanwhile, the delivery system 106 records completed conversion actions by the user associated with at least one of the invitational content (306). As described above, the delivery system 106 includes a user-profile database 124. In some embodiments, the delivery system 106 can receive a direct request to update one or more user profiles. The update request can come directly from the user or any other device capable of communicating with the delivery system 106, such as other content delivery networks or websites. The update request can occur at any time with respect to the conversion. For example, as the conversion occurs an update request can be sent or one or more completed conversions can be stored and sent at a later time. The request can include a record of completed conversion actions for the specified users. Alternatively, the request for a content package can include a record of completed conversion actions by the requesting user. The record of completed conversion actions can be supplied to the user-profile-update module 126, which will update the user profiles for the users identified in the request.

The content delivery system 106 designates the invitational content that has a completed conversion associated therewith as exempt from distribution to the user (308). In one embodiment this can be performed by the pool-processing module 122. As described above, the pool-processing module 122 receives a context and identifying information for the user associated with the request. The pool-processing module 122 also either receives or creates a pool of invitational content. The pool-processing module accesses the user profile database 124 to retrieve the most up to date user profile of completed conversion actions for previously presented invitational content. The pool-processing module 122 examines the invitational content and if the user profile indicates a completed conversion for any particular invitational content then it excludes the content from the user-specific pool. The user-specific pool can be the same pool as the original candidate pool where the invitational content is marked as included and/or excluded. For example, the processing pool module 122 could check, for each invitational content in the pool, the user profile for a completed conversion. If the profile indicates a completed conversion, the invitational content is designated excluded. Once the pool-processing module 122 designates all invitational content for which the user has completed the conversion action as excluded, any of the non-designated invitational content can be used in the content package presented to the user. Alternatively, the user-specific pool can be an entirely separate pool that only includes invitational content for which the user has yet to complete the conversion action. Then any of the invitational content in the resulting user-specific pool can be used in the content package presented to the user.

In some embodiments, invitational content that was previously excluded from the user-specific pool can be re-included. The user-profile-update module 126 can be configured to adjust the data in user-profile database 124 so that a completed conversion expires after a specified period of time. That is, even if the user has completed the conversion action for the invitational content, after a specified period of time it is considered that the user has yet to complete the conversion. In some embodiments, rather than relying on expiring conversions, the user-profile-update module can learn directly from the user terminal 102 or a content provider that the conversion has been reversed. This can happen, for example, if a conversion required download of a program, but the user uninstalled the program.

When a completed conversion action is noted as reversed, the pool-processing module 122 can either update the user-specific pool or create a new user-specific pool. For example, if the user-specific pool is simply the original-invitational-content pool with the content marked as excluded, then the pool-processing module 122 can update the pool by removing the exclude designation. Alternatively, if the user-specific pool is a completely separate pool then the pool-processing module 122 can update the user-specific pool by adding in the invitational content that is no longer considered to have a completed conversion action.

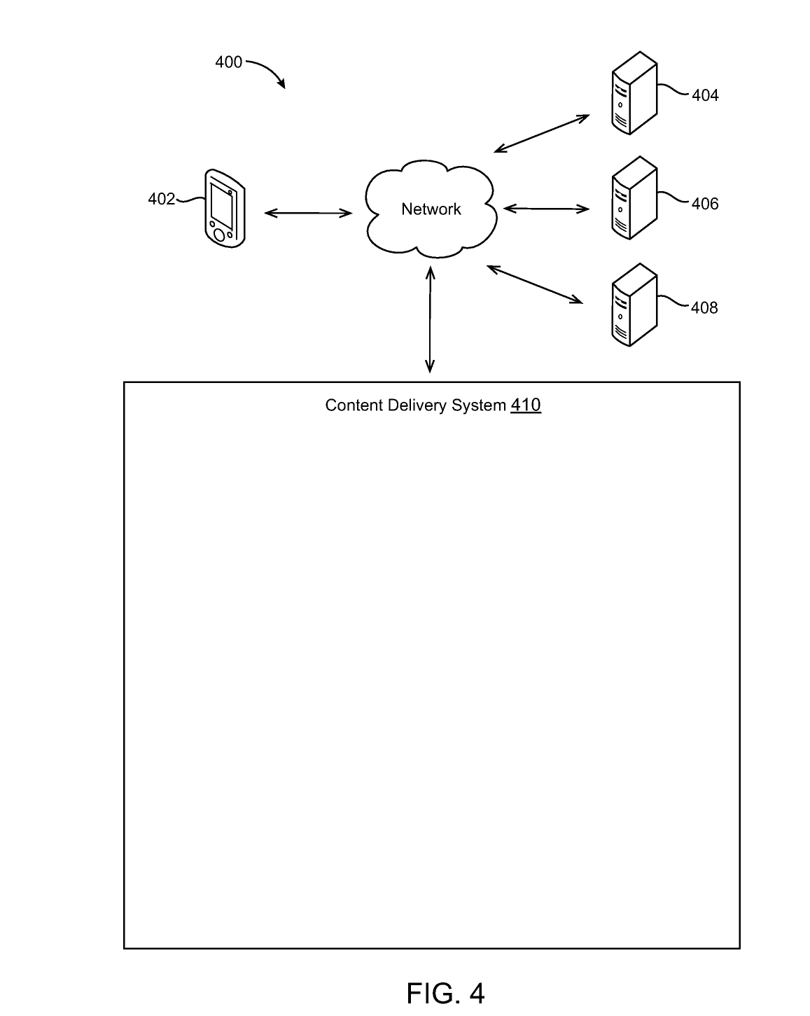

The disclosure now turns to an illustrative example of selecting an invitational content when audience exclusion is enabled. In this illustration, the invitational content takes the form of an advertisement. FIG. 4 illustrates an exemplary configuration of devices and a network (400). Content provider 404 is an electronic commerce retailer that sells a mobile phone as well as a variety of accessories for the phone. Content provider 404 has contracted with primary content providers 406 and 408 to display advertisements for content provider 404's mobile phone and/or the associated accessories on their websites. Content provider 404 has deposited a variety of advertisements with the content delivery system 410 along with usage criteria for each advertisement. These advertisements are stored in the content database.

The user of mobile phone 402 visits the website of primary content provider 406. When this occurs, a request is sent to the content delivery system 410 for a content package. The request includes a set of criteria that specifies the known information about the user 402 and the contextual characteristics. Based on the supplied context, the delivery system obtains the pool of advertisements supplied by content provider 404 from the content database. Because there are multiple possible advertisements, the delivery system obtains the user profile for user 402 from the user profile database. The user profile indicates that user 402 has yet to complete any of the conversion actions associated with the possible advertisements. Thus, the pool processing module makes no changes to the pool of candidate advertisements. Content provider 404 supplied a usage criteria for this scenario to instruct the delivery system 410 to select a general advertisement for the content provider 404's e-commerce website.

The selected advertisement is presented to the user 402 in the form of a banner ad on primary content provider 406's website. The user 402, sees the advertisement, clicks on it, and is redirected to content provider 404's website. Once at content provider 404's website, the user 402 ultimately completes a conversion by purchasing the offered mobile phone. Upon completing the conversion action associated with the advertisement, an update request is sent to the delivery system 410 instructing it to update the user profile for the user 402, which is handled by the user profile update module.

After purchasing the mobile phone, the user 402 navigates to the website for primary content provider 408. As with content provider 406, a request for an advertisement is sent to the delivery system 410 that includes the content and the known information about the user 402. Again the system content delivery system 410 obtains the pool of possible advertisements for content provider 404 from the content database. This time when the delivery system 410 checks the user profile for the user 402, it discovers the mobile phone purchase conversion. Based on this information, the pool processing module removes the advertisements that have an associated conversion action of mobile phone purchase from the pool of possible advertisements. The delivery system 410 then selects an advertisement from the remaining pool of candidate advertisements, which in this case is a general advertisement for accessories for content provider 404's mobile phone. The selected advertisement is presented to the user 402 on content provider 408's website.

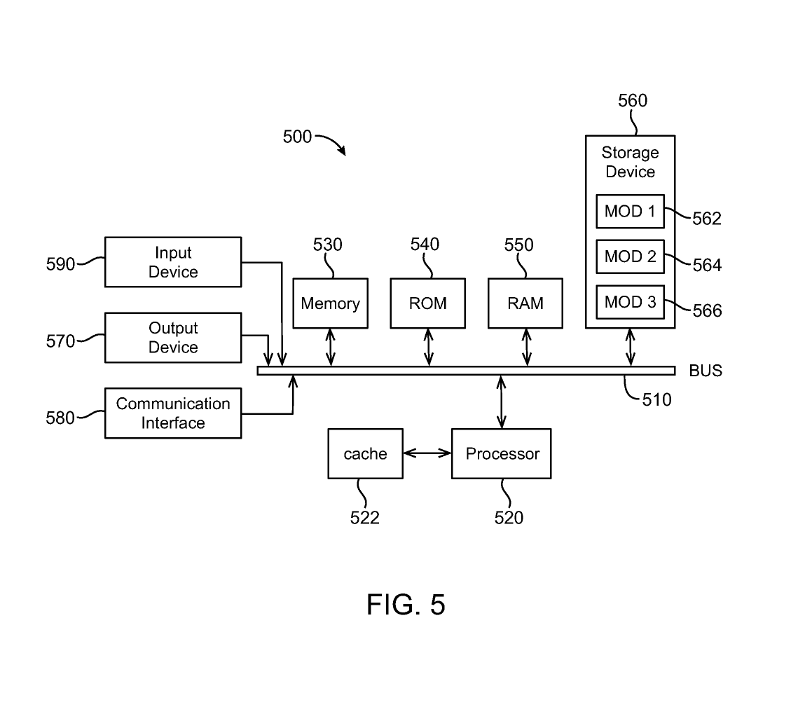

With reference to FIG. 5, an exemplary system 500 includes a general-purpose computing device 500, including a processing unit (CPU or processor) 520 and a system bus 510 that couples various system components including the system memory 530 such as read only memory (ROM) 540 and random access memory (RAM) 550 to the processor 520. The system 500 can include a cache 522 of high speed memory connected directly with, in close proximity to, or integrated as part of the processor 520. The system 500 copies data from the memory 530 and/or the storage device 560 to the cache 522 for quick access by the processor 520. In this way, the cache 522 provides a performance boost that avoids processor 520 delays while waiting for data. These and other modules can be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer readable storage media provide nonvolatile storage of computer readable instructions, data structures, program modules and other data for the computing device 500. In one aspect, a hardware module that performs a particular function includes the software component stored in a non-transitory computer-readable medium in connection with the necessary hardware components, such as the processor 520, bus 510, display 570, and so forth, to carry out the function. The basic components are known to those of skill in the art and appropriate variations are contemplated depending on the type of device, such as whether the device 500 is a small, handheld computing device, a desktop computer, or a computer server.

Although the exemplary embodiment described herein employs the hard disk 560, it should be appreciated by those skilled in the art that other types of computer readable media which can store data that are accessible by a computer, such as magnetic cassettes, flash memory cards, digital versatile disks, cartridges, random access memories (RAMs) 550, read only memory (ROM) 540, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations discussed below, and random access memory (RAM) 550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5 can practice all or part of the recited methods, can be a part of the recited systems, and/or can operate according to instructions in the recited non-transitory computer-readable storage media. Such logical operations can be implemented as modules configured to control the processor 520 to perform particular functions according to the programming of the module. For example, FIG. 5 illustrates three modules Mod1 562, Mod2 564 and Mod3 566 which are modules controlling the processor 520 to perform particular steps or a series of steps. These modules may be stored on the storage device 560 and loaded into RAM 550 or memory 530 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1-20. (canceled)

21. A method comprising:
transmitting, by a server to a computing device associated with a user, a first item of invitational content selected from a pool of invitational content, wherein the first item of invitational content comprises an offer for the user to complete a conversion action associated with the first item of invitational content by performing a series of pre-defined actions leading to the conversion action in response to a presentation of the first item of invitational content at the computing device;
determining that the user associated with the computing device failed to complete the conversion action in response to the presentation of the first item of invitational content at the computing device;
determining which of the series of pre-defined actions were not performed by the user at the computing device, to yield a determination of uncompleted actions;
based on the determination of uncompleted actions, identifying a cause for the user's failure to complete the conversion action; and
based on the cause, transmitting, to the computing device, an instruction to re-present the first item of invitational content at the computing device according to a different presentation configuration, the different presentation configuration comprising a different series of pre-defined actions for completing the conversion action while avoiding the cause for the user's failure to complete the conversion action.

22. The method of claim 21, further comprising monitoring, by the server, the computing device to determine that the conversion action was not achieved in response to the presentation of the first item of invitational content at the computing device.

23. The method of claim 21, further comprising:
determining that the conversion action has been completed at the computing device in response to re-presenting the first item of invitational content at the computing device according to the different presentation configuration; and
designating the first item of invitational content as exempt from future distribution to the computing device.

24. The method of claim 21, further comprising:
identifying at least one item of invitational content other than the first item, wherein the at least one item of invitational content is associated with the conversion action; and
in response to determining that the conversion action has been completed, designating the at least one item of invitational content as exempt from future distribution to the computing device.

25. The method of claim 21, wherein the different presentation configuration enables the conversion action to be completed with fewer number of pre-defined actions than a number of pre-defined actions associated with the series of pre-defined actions leading to the conversion action in response to the presentation of the first item of invitational content at the computing device.

26. The method of claim 21, wherein determining which of the series of pre-defined actions were not performed by the user at the computing device comprises determining that a set of information requested from the user was not submitted by the computing device, and wherein the cause for the user's failure to complete the conversion action comprises a request for submitting the set of information.

27. The method of claim 26, wherein the different presentation configuration avoids requesting submission of at least a portion of the set of information.

28. A computer-readable device comprising computer-executable instructions stored thereon for causing a machine to perform operations comprising:
transmitting, to a computing device associated with a user, a first item of invitational content selected from a pool of invitational content, wherein the first item of invitational content comprises an offer for the user to complete a conversion action associated with the first item of invitational content by performing a series of pre-defined actions leading to the conversion action in response to a presentation of the first item of invitational content at the computing device;
determining that the user associated with the computing device failed to complete the conversion action in response to the presentation of the first item of invitational content at the computing device;
determining which of the series of pre-defined actions were not performed by the user at the computing device, to yield a determination of uncompleted actions;
based on the determination of uncompleted actions, identifying a cause for the user's failure to complete the conversion action; and
based on the cause, transmitting, to the computing device, an instruction to re-present the first item of invitational content at the computing device according to a different presentation configuration, the different presentation configuration comprising a different series of pre-defined actions for completing the conversion action while avoiding the cause for the user's failure to complete the conversion action.

29. The non-transitory computer-readable medium of claim 28, the operations further comprising monitoring, by the server, the computing device to determine that the conversion action was not achieved in response to the presentation of the first item of invitational content at the computing device.

30. The non-transitory computer-readable medium of claim 28, the operations further comprising:
determining that the conversion action has been completed at the computing device in response to re-presenting the first item of invitational content at the computing device according to the different presentation configuration; and
designating the first item of invitational content as exempt from future distribution to the computing device.

31. The non-transitory computer-readable medium of claim 28, the operations further comprising:
identifying at least one item of invitational content other than the first item, wherein the at least one item of invitational content is associated with the conversion action; and
in response to determining that the conversion action has been completed, designating the at least one item of invitational content as exempt from future distribution to the computing device.

32. The non-transitory computer-readable medium of claim 28, wherein the different presentation configuration enables the conversion action to be completed with fewer number of pre-defined actions than a number of pre-defined actions associated with the series of pre-defined actions leading to the conversion action in response to the presentation of the first item of invitational content at the computing device.

33. The non-transitory computer-readable medium of claim 28, wherein determining which of the series of pre-defined actions were not performed by the user at the computing device comprises determining that a set of information requested from the user was not submitted by the computing device, and wherein the cause for the user's failure to complete the conversion action comprises a request for submitting the set of information.

34. The non-transitory computer-readable medium of claim 33, wherein the different presentation configuration avoids requesting submission of at least a portion of the set of information.

35. A system comprising:
a processor; and
a computer-readable storage medium having stored therein instructions which, when executed by the processor, cause the processor to perform operations comprising:
transmitting, to a computing device associated with a user, a first item of invitational content selected from a pool of invitational content, wherein the first item of invitational content comprises an offer for the user to complete a conversion action associated with the first item of invitational content by performing a series of pre-defined actions leading to the conversion action in response to a presentation of the first item of invitational content at the computing device;
determining that the user associated with the computing device failed to complete the conversion action in response to the presentation of the first item of invitational content at the computing device;
determining which of the series of pre-defined actions were not performed by the user at the computing device, to yield a determination of uncompleted actions;
based on the determination of uncompleted actions, identifying a cause for the user's failure to complete the conversion action; and
based on the cause, transmitting, to the computing device, an instruction to re-present the first item of invitational content at the computing device according to a different presentation configuration, the different presentation configuration comprising a different series of pre-defined actions for completing the conversion action while avoiding the cause for the user's failure to complete the conversion action.

36. The system of claim 35, wherein determining which of the series of pre-defined actions were not performed by the user at the computing device comprises determining that a set of information requested from the user was not submitted by the computing device, and wherein the cause for the user's failure to complete the conversion action comprises a request for submitting the set of information.

37. The system of claim 36, wherein the different presentation configuration avoids requesting submission of at least a portion of the set of information.

38. The system of claim 35, the operations further comprising:
determining that the conversion action has been completed at the computing device in response to re-presenting the first item of invitational content at the computing device according to the different presentation configuration; and
designating the first item of invitational content as exempt from future distribution to the computing device.

39. The system of claim 35, the operations further comprising:
identifying at least one item of invitational content other than the first item, wherein the at least one item of invitational content is associated with the conversion action; and in response to determining that the conversion action has been completed, designating the at least one item of invitational content as exempt from future distribution to the computing device.

40. The system of claim 35, wherein the different presentation configuration enables the conversion action to be completed with fewer number of pre-defined actions than a number of pre-defined actions associated with the series of pre-defined actions leading to the conversion action in response to the presentation of the first item of invitational content at the computing device.
